(19) United States
(12) Patent Application Publication
(10) Pub. No.: US 2002/0156604 A1
(43) Pub. Date: Oct. 24, 2002

(54) Method for residual form in molecular modeling

(75) Inventor: Dan E. Rosenthal, Los Altos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Protein Mechanics, Mountain View, CA

(21) Appl. No.: 10/053,354

(22) Filed: Nov. 2, 2001

Related U.S. Application Data
(60) Provisional application No. 60/245,731, filed on Nov. 2, 2000.
(60) Provisional application No. 60/245,730, filed on Nov. 2, 2000.
(60) Provisional application No. 60/245,688, filed on Nov. 2, 2000.
(60) Provisional application No. 60/245,734, filed on Nov. 2, 2000.

(51) Int. Cl. G06F 17/10

(52) U.S. Cl. 703/2

(57) ABSTRACT

The Residual Form of the equations of motion of a molecular model is used to reduce the computational load by a factor of approximately 7 as compared to the conventional Direct Form (not including the force computations). Implicit integrators are used with the Residual Form, especially L-stable integrators, such as implicit Euler and Radau5. A preferable molecular model is an Order (N), torsion angle, rigid multibody system.

### CROSS-REFERENCES TO RELATED APPLICATIONS

This application is entitled to the benefit of the priority filing date of Provisional U.S. Patent Application No. 60/245,731, filed Nov. 2, 2000, and in addition, co-pending Provisional U.S. Patent Application Nos. 60/245,730, filed Nov. 2, 2000; 60/245,688, filed Nov. 2, 2000; and 60/245,734, filed Nov. 2, 2000; all of which are hereby incorporated by reference in their entirety for all purposes.

### BACKGROUND OF THE INVENTION

The present invention is related to the field of molecular modeling and, more particularly, to computer-implemented methods for the modeling large molecules in which accelerations appear in the formulation.

The motion of bodies are determined by Newton's Laws of Motion. For a body subject to a force, Newton's Second Law:

F=ma

or the acceleration of the body of mass is equal to the total force upon the body is applicable. This simple equation hides enormous complexity for the dynamic modeling and static analysis of large molecules. The acceleration of the body is the time derivative of velocity of the body and to determine the velocity of the body, its acceleration must be integrated with respect to time. Likewise, the velocity of a body is the time derivative of position of the body and to determine the position of the body, its velocity must be integrated with respect to time. Thus with knowledge of the force upon a body, integration operations must be performed to determine the velocity and position of the body at a given time.

In a molecule, there are multiple bodies whose motions must be considered. Each body, an atom or collection of atoms, of the molecule is subject to multiple and complex forces. Thus the calculation of the motion and the shape of the molecule requires the determination of the position and motion of each atom of the molecule. Hence the calculation of the structure, dynamics and thermodynamics of molecules, including complex molecules having thousands of atoms, by computers would seem to be the perfect answer.

Indeed, the field of molecular modeling has successfully simulated the motion (molecular dynamics or MD) and the rest states (static analysis) of many complex molecular systems by computers. Typical molecular modeling applications have included enzyme-ligand docking, molecular diffusion, reaction pathways, phase transitions, and protein folding studies. Researchers in the biological sciences and the pharmaceutical, polymer, and chemical industries are beginning to use these techniques to understand the nature of chemical processes in complex molecules and to design new drugs and materials accordingly. Naturally, the acceptance of these tools is based on several factors, including the accuracy of the results in representing reality, the size of the molecular system that can be modeled, and the speed by which the solutions are obtained. The accuracy of the solutions are generally accepted. However, the use of these tools up to now has required enormous computing power to model molecules or molecular systems of even modest size or to obtain molecular time histories of sufficient length to be useful.

There are two sources of computational complexity for most molecular modeling simulations of a large molecule:

1. The particular molecular model which is used to describe the locations, velocities and mass properties of the constituent atoms, the inter-atomic forces between them, and the interactions between the atoms and their surrounding environment: and.

2. The particular numerical method used to advance the model through time. Time is advanced repeatedly by very short intervals, called timesteps, until a final time has been reached.

Substantial work has been completed in reducing the computational load for molecular models, such as the reduction of model complexity by constraining higher order modes with rigid body assumptions, Order(N) dynamics, and multi-pole methods for the force field models (see, for example, U.S. Pat. No. 5,424,963 on the commercial MBO(N)D software package). The typical formulation method in which the molecular model computes the accelerations of constituent masses is called the “Direct Form” of the equations of motion.

The present invention is directed toward the improvements in the molecular model. This invention provides for an alternative formulation of the molecular model so that fewer computations are required to reach the same result. This alternative method is known as the “Residual Form” of the equations of motion. In this method, only an error, or residual, is calculated such that driving this error to zero ensures that the equations of motion are satisfied. Related methods have been described for use with some numerical integration methods, and in conjunction with mechanical system simulations. For example, see Von Schwerin, Multibody System Simulation, Springer, 1999. One example of prior art that uses the Residual Form include commercial mechanical engineering code sold as SD/FAST. This software provides a Residual Form of the equations (M. Hollars, et. al., SD/FAST User's Manual, Version B.2, 1994, p.R-15). Another example includes DAE methods using implicit integration, for example, the DASSL code (Brenan, et. al., Numerical Solution of Initial-Value Problems in Differential-Algebraic Equations, North-Holland, N.Y., 1989, Chapter 5), which expects a Residual Form of the equations to be integrated. Also, residual formulation for mechanical multibody simulations is discussed in A. Eichberger, et. al., “The Benefits of Parallel Multibody Simulations” in International Journal for Numerical Methods in Engineering, Vol. 37, pp. 1557-1572, 1994.

Attempts have been made to apply residual (or error) functions rather than direct computation of state derivatives to the integration problem when using implicit integration methods. These attempts did not lead to any practical success, in large part because the mechanical systems to which the method were applied were highly cyclic in nature (cyclic meaning many closed loops in the system topology). This necessitated the introduction of additional algebraic quantities into the system description and this complication led to poor conditioning of the equation which caused failure of a certain numerical step central to implicit integrators.

However, molecular models are almost entirely acyclic (very few or no loops in the system topology), and the additional algebraic variables do not need to be introduced into the system model. In the present invention the Residual Form is able to provide a significant speedup to a portion of the computation with a much simpler formulation of the molecular model and its equations of motion. It is believed that Residual Form has never been used in conjunction with molecular modeling and in particular, MD simulations, primarily because MD simulations are usually devised to use explicit numerical methods to advance the molecular model through time, whereas the Residual Form requires the use of implicit numerical methods (see co-pending U.S. patent application Ser. No. ______, entitled “METHOD FOR LARGE TIMESTEPS IN MOLECULAR MODELING” and filed on even date, which claims priority from the previously referenced provisional patent applications, and which co-pending application is incorporated by reference in its entirety).

The present invention teaches the application of the Residual Form to molecular modeling. By casting MD equations in Residual Form rather than the standard Direct Form, the number of computer operations required to calculate the non-force terms of these equations are drastically reduced. The computational cost of function evaluations in an MD simulation is a significant fraction of the whole simulation and anything that might reduce this cost is potentially of great benefit For the preferred embodiment using an Order(N) torsion-angle model with simple active forces, the operation count is reduced by approximately a factor of seven. Of course, the effect on the entire simulation time depends upon the relative costs of the other portions of the computation, and will always be less dramatic than the effect on the model cost alone.

### SUMMARY OF THE INVENTION

The present invention teaches a method of computer modeling the behavior of a molecule. The method comprises selecting a model for the molecules, the model having equations of motion for the molecules; formulating the equations of motion in Residual Form; and integrating the model equations with an implicit integrator, to reduce the computer calculations for the molecular behavior. The equations of motion in Residual Form comprise

$$( \begin{matrix}{ρ}_{q} \\ {ρ}_{u}\end{matrix} ) = ( \begin{matrix}\dot{q} - W ( q ) u \\ M ( q ) \dot{u} - f ( t , q , u )\end{matrix} )$$

where q represents generalized system coordinates, u represents generalized velocities, W represents a generalized joint map matrix, M represents generalized system mass, and f represents generalized system forces. The selected model preferably comprises an Order(N) torsion-angle, rigid multibody system, such as a model with a plurality of rigid bodies, each rigid body representing a portion of the molecule; and a plurality of hinge connections, each hinge connection defining the allowable relative motion between two of the rigid bodies.

The present invention also provides for computer code for modeling the behavior of a molecule. The code comprises a model module for the molecules with equations of motion in Residual Form for the molecules; and module having an implicit integrator for integrating the model equations over time to reduce the computer calculations to model the molecular behavior. The model module is preferably for an Order(N) torsion-angle, rigid multibody system.

### BRIEF DESCRIPTION OF THE DRAWINGS

FIG. 1 is a representational block module diagram of the software system architecture in accordance with the present invention;

FIG. 2 illustrates the tree structure of the multibody system of the molecular model according to the present invention;

FIG. 3 illustrates the reference configuration of the FIG. 2 multibody system;

FIG. 4A illustrate a sliding joint between two bodies of the FIG. 2 multibody system;

FIG. 4B illustrate a pin joint between two bodies of the FIG. 2 multibody system;

FIG. 4C illustrate a ball joint between two bodies of the FIG. 2 multibody system;

FIG. 5 summarizes general computational steps for the Residual Form method and Direct Form methods of the molecular dynamics computations; and

FIG. 6 is a table which compares the approximate number of computations required for the Direct Form vs. the Residual Form methods for several exemplary MD models.

### DESCRIPTION OF THE SPECIFIC EMBODIMENTS

To solve ordinary differential equations (ODEs), most of the prior art have used equations expressed in the Direct Form, i.e.,

$$\dot{y} = f ( y , t ) ( w h e r e \dot{y} m e a n s \frac{ⅆ y}{ⅆ t} ) .$$

The equations of motion for a biomolecular system can be cast into this form (and called the Direct Form). In molecular modeling, all prior art known to the present inventors have used the Direct Form. That is, \dot{q}=Wu, \dot{u}=M⁻¹ƒ, where q and u are generalized coordinates and speeds respectively, so that conventional ODE solution methods can be applied. However, this requires a matrix inversion of M (representing the mass of the system) at a cost of Order(N) to Order(N³) floating point operations (depending on algorithm used, where N is the number of degrees of freedom in the system), since the natural form of the equations gives rise to inertial coupling between the derivatives of the generalized speeds. That is, the equations are most naturally produced in the form \dot{q}−Wu=0, M\dot{u}−f =0, where M, the mass matrix, depends explicitly upon the generalized coordinates q, i.e., M=M(q). This fact requires forming and effectively factoring the mass matrix each time the state derivatives are needed by the integrator in integrating the equations of motion over time. The generalized joint map matrix W is block diagonal and, although it is also dependent on the coordinates W=W(q), it does not have a significant computational cost.

In accordance with the present invention, a method for the solution of the equations of a molecular system is expressed in Residual Form to bypass the customary step of producing the state derivatives directly. The Residual Form method has the following steps:

1) Discretization of the solution variables. The specific form of discretization is dictated by the particular implicit integration method used to advance the molecular model in time. Implicit integration follows from the Residual Form. Implicit integration, especially L-stable integrators and other highly stable integrators, such as implicit Euler, Radau5, SDIRK3, SDIRK4, other implicit Runge-Kutta methods, and DASSL or other implicit multistep methods, also provide other advantages for molecular modeling. See, for example, the above-cited U.S. patent application. Ser. No. ______, entitled “METHOD FOR LARGE TIMESTEPS IN MOLECULAR MODELING,” filed of even date. As a particularly simple example, when used with implicit Euler integration, the discretization is as follows:

\dot{q}=(qₙ−qₙ₋₁)/h, |\dot{u}=(uₙ−uₙ₋₁)/h

where h is the timestep.

2) Substitution into the residual equations:

$$( \begin{matrix}{ρ}_{q} \\ {ρ}_{u}\end{matrix} ) = ( \begin{matrix}\dot{q} - W ( q ) u \\ M ( q ) \dot{u} - f ( t , q , u )\end{matrix} )$$

3) Solution of the resulting nonlinear algebraic equations

$$( \begin{matrix}{ρ}_{q} \\ {ρ}_{u}\end{matrix} ) = 0$$

for qₙ and uₙ.

The kinematic residual ρ_{q} compares an estimated \dot{q} generated from the implicit integrator to the derivatives computed by the routines for determining the joints of the molecular model, which is described in greater detail below. The second row of the residual is ρₙ, the dynamic residual, which determines the degree to which an estimated \dot{u} satisfies the equations of motion.

The system mass matrix M and the so-called ‘bias-free hinge torque’ ƒ are both state dependent. The bias-free hinge torque is generated by the dynamic residual routine when the calculated \dot{u} vector passed to the residual routine is zero. In general, the hinge accelerations are a response to applied forces, joint torques, and motion-induced effects (such as Coriolis and centrifugal forces.) If the system were at rest, and subjected only to joint torques, it would be considered in a bias-free state. The real system with its actual inputs can be reduced to a bias-free state by computing a set of joint torques equivalent to the biased inputs. Both sets produce the same hinge accelerations.

The preferred embodiment of the Residual Form is shown for an Order(N) torsion-angle, rigid-body for the molecular model. The following sections develop the molecular model from basic definitions and show how the model is used to compute the motion of the model. First, the overall computer code architecture for the molecular model simulation is described. Then an Order(N) torsion-angle, rigid multibody system is derived, along with notation used, the reference configuration, the definitions of the joints between the bodies, generalized coordinates, and generalized speeds. This approach for dynamics is similar to that used by T. R. Kane (Dynamics, 3^{rd} ed., 1978.)

Molecular Dynamics Simulation Architecture

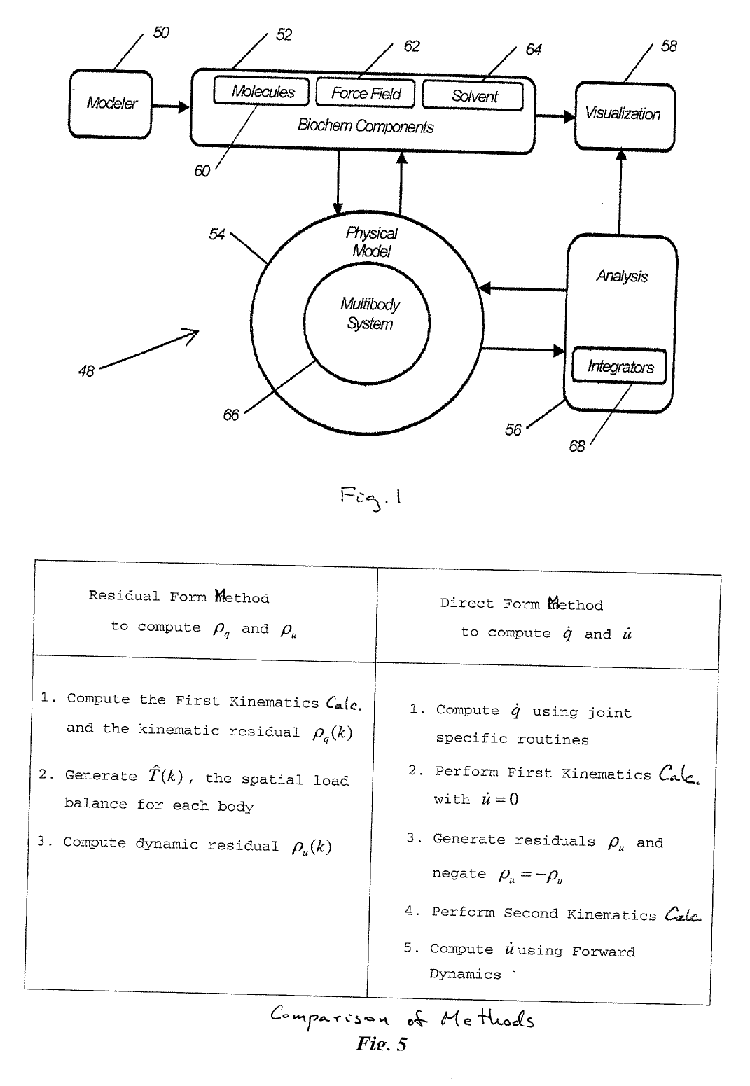

The general system architecture 48 of the software and some of its processes for modeling molecules in accordance with the present invention are illustrated in FIG. 1. Each large rectangular block represents a software module and arrows represents information which passes between the software modules. The software system architecture has a modeler module 50, a biochem components module 52, a physical model module 54, an analysis module 56 and a visualization module 58. The details of some of these modules are described below; other modules are available to the public.

The modeler module 50 provides an interface for the user to enter the physical parameters which define a particular molecular system. The interface may have a graphical or data file input (or both). The biochem components module 52 translates the modeler input for a particular mathematical model of the molecular system and is divided into translation submodules 60, 62 and 64 for mathematical modeling the molecule(s), the force fields and the solvent respectively of the system being modeled. There are several modeler and biochem components modules available including, for example, Tinker (Jay Ponder, TINKER User's Guide, Version 3.8, October 2000, Washington University, St. Louis, Mo).

With the translated physical parameters from the biochem components module 52, the physical model module 54 defines the molecular system mathematically. At the core of the module 54 is a multibody system submodule 66. The physical model module 54 and multibody system submodule 66 are described below in detail. Co-pending application, U.S. patent application Ser. No. ______, entitled, “METHOD FOR ANALYTICAL JACOBIAN COMPUTATION IN MOLECULAR MODELING,” and filed on even date, which claims priority from the previously referenced provisional patent applications and which co-pending application is incorporated by reference in its entirety, has further descriptions of the physical model module 54 and multibody submodule 66.

The analysis module 56, which communicates with the physical model module 54 and the visualization module 58, provides solutions to the computational models of the molecular systems defined by the physical model module 54. The analysis module 56 consists of a set of integrator submodules 68 which integrate the differential equations of the physical model module 54. The integrator submodules 68 advance the molecular system through time and also provide for static analyses used in determining the minimum energy configuration of the molecular system. The analysis module 56 and its integrator submodules 68 contain most of the subject matter of the present invention and are described in detail below.

The visualization module 58 receives input information from the biochem components module 52 and the analysis module 56 to provide the user with a three-dimensional graphical representation of the molecular system and the solutions obtained for the molecular system. Many visualization modules are presently available, an example being VMD (A. Dalke, et al., VMD User's Guide, Version 1.5, June 2000, Theoretical Biophysics Group, University of Illinois, Urbana, Ill).

The described software code is run on conventional personal computers, such as PCs with Pentium III or Pentium IV microprocessors manufactured by Intel Corporation of Santa Clara, Calif. This contrasts with many current efforts in molecular modeling which use supercomputers to perform calculations. Of course, further speed improvements can be obtained by running the described software on faster computers.

MOLECULAR MODEL AND MULTIBODY SYSTEM DESCRIPTION

The integrators described below in the submodule 68 operate upon a set of equations which describe the motion of the molecular model in terms of a multibody system (MBS). To aid the computation of the integration methods described in detail below, a torsion angle, rigid body model is used to describe the subject molecule system, in accordance with the present invention. Internal coordinates (selected generalized coordinates and speeds) are used to describe the states of the molecule.

The MBS is an abstraction of the atoms and effectively rigid bonds that make up the molecular system being modeled and is selected to simplify the actual physical system, the molecule in its environment, without losing the features important to the problem being addressed by the simulation. With respect to the general system architecture illustrated in FIG. 1, the MBS does not include the electrostatic charge or other energetic interactions between atoms nor the model of the solvent in which the molecules are immersed. The force fields are modeled in the submodule 62 and the solvent in the submodule 64 in the biochem components module 52.

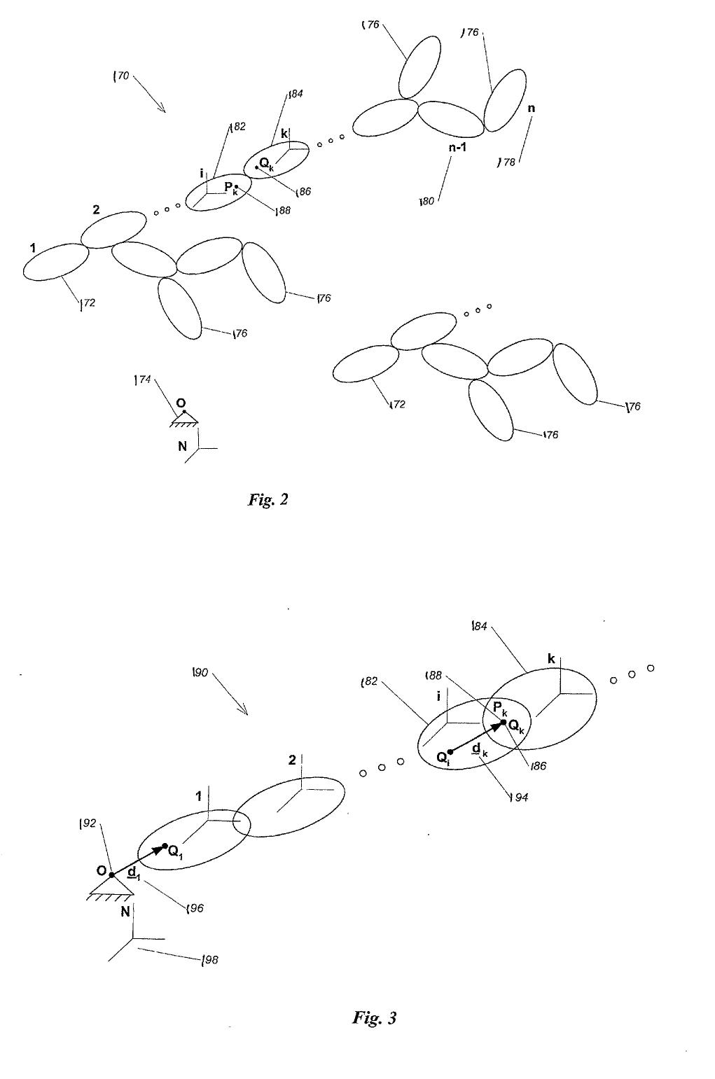

FIG. 2 illustrates the tree structure of the MBS of a subject molecule. The basic abstraction of the MBS is that of one or more collections of hinge-connected rigid bodies 170. A rigid body is a mathematical abstraction of a physical body in which all the particles making up the body have fixed positions relative to each other. No flexing or other relative motion is allowed. A hinge connection is a mathematical abstraction that defines the allowable relative motion between two rigid bodies. Examples of these rigid bodies and hinge connections are described below.

One or more of the bodies, called base bodies 172, have special status in that their kinematics are referenced directly to a reference point on ground 174. The system graph is one or more “trees”. An important property of a tree is that the path from any body to any other body is unique, i.e., the graph contains no loops. The bodies in the tree are n in number (the base has the label 1). The bodies in the tree are assigned a regular labeling, which means that the body labels never decrease on any path from the base body to any leaf body 176. A leaf body is one that is connected to only a single other body. A regular labeling can be achieved by assigning the label n to one of the leaf bodies 178 (there must be at least one). If this body is removed from the graph, the tree now has n−1 bodies. The label n−1 is then assigned to one of its leaf bodies 180, and the process is repeated until all the bodies have been labeled. This is also done for any remaining trees in the system.

To help maintain the relationship between the bodies, an integer function is used to record the inboard body for each body of the system. The inboard body for each base is ground and i, the parent or inboard body 182 for body k 184, is referred to as i=inb(k). Additionally, the symbol N refers to the inertial, or ground frame 174. A superscript O refers to the ground origin (0,0,0).

The symbol for the vector from one point to another contains the name of the two points. Thus, r^{PQ} is the vector from the point P to point Q. A vector representing the velocity of a point in a reference frame contains the name of the point and the reference frame: ^{N}v^{P}. Certain symbols to be introduced later relate two reference frames. In this case, the symbol contains the name of two frames. Thus, ⁱC^{k} is the direction cosine matrix for the orientation of frame k in frame i. This symbol refers to the direction cosine matrix for a typical body in its parent frame. Thus, ⁱC^{k}(j) indicates the actual body j in question. The left and right superscripts do not change with the body index. This is also true for the other symbols. An asterisk indicates the transpose: H*(k), for example. A tilde over a vector indicates a 3 by 3 skew-symmetric cross product matrix: \tilde{v}w^{Δ}v×w. Eᵢ is an i by i identity matrix., and 0ⁱ is a zero vector of length i and 0ᵢ is an i by i zero matrix.

Rigid Bodies of the Model

FIG. 3 illustrates the reference configuration 190 of a sample “tree” of the MBS. More than one tree is allowed. A point of each body is designated as Q, its hinge point. For example point Qₖ 186 is the hinge point for body k 184. A fixed set of coordinate axes is established in the inertial frame 198. An arbitrary configuration of the MBS is chosen as its reference configuration 190. While in this configuration the image of the inertial coordinate axes is used to establish a set of body-fixed axes in each body. In the reference configuration each hinge point Q is coincident with P, a point of its parent body (or extended body.) For each body, point P is called the body's inboard hinge point. So the inboard hinge point Pₖ 188 for body k 184 is a point fixed in its parent body i 182. The inboard hinge point for each base body is a point O 192 fixed in ground. The expanded view that shown in FIG. 2 more clearly shows that point Qₖ 186 is fixed in body k 184 and point Pₖ 188 is fixed in parent body i 182.

The hinge point locations define d(k) 194, a constant vector for each body, and can also be written r^{Q}^{ᵢ}^{P}^{ₖ}. The vector for body k is fixed in its parent body i. It spans from the hinge point for body i to the inboard hinge point for body k. The vector d(1) 196 spans from the inertial origin to the first base body's inboard hinge point (also a point fixed in ground), and can be written r^{OQ}^{ᵢ}.

For a body, m(k), p(k), and I_{Q}_{ₖ} (k) define the mass properties of body k for its hinge point Qₖ. These are, respectively, the mass, the first mass moment, and the inertia matrix of the body for its hinge point in the coordinate frame of the body. For a rigid body made up of a distribution of particles, the mass properties are constants that are computed by a preprocessing module. The details of these computations can be found in standard references, such as Kane, T. R., Dynamics, 3^{rd} Ed., January 1978, Stanford University, Stanford, Calif.

Let M(k), the spatial inertia of body k for its hinge point Qₖ, be given by the symmetric 6 by 6 matrix

$$M ( k ) = [ \begin{matrix}{\underline{\underline{I}}}_{{Q}_{k}} ( k ) & \tilde{p} ( k ) \\ - \tilde{p} ( k ) & m ( k ) {\underline{\underline{E}}}_{3}\end{matrix} ]$$

Each joint in the system is described by geometric data. For instance, a pin joint is characterized by an axis fixed in the two bodies connected by the joint. The particular data for a joint depends on its type. The number n, the inb function, the system mass properties, the vectors d(k), and the joint geometric data (including joint type) constitute the system parameters.

Joints and Generalized Coordinates of the Model

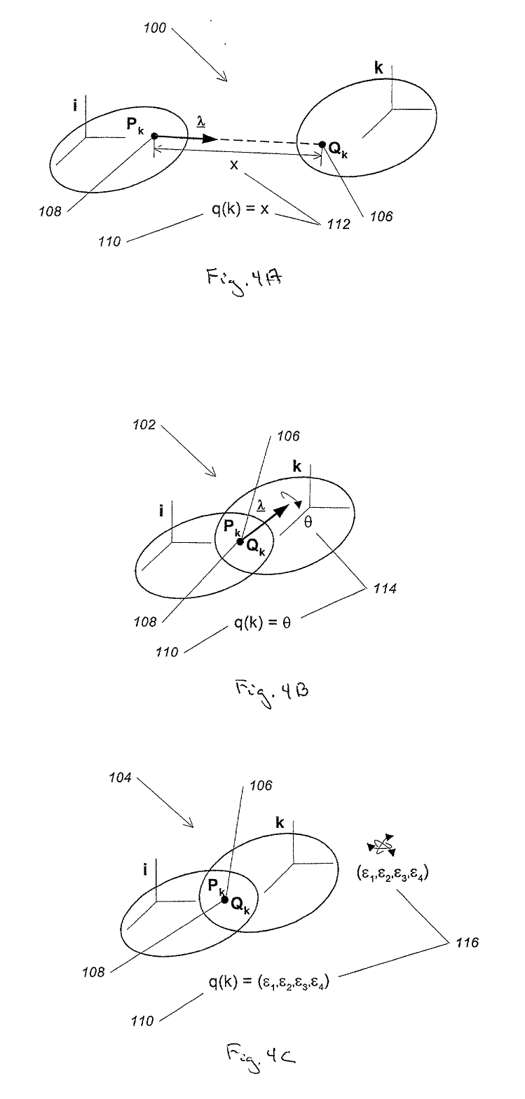

FIG. 4 illustrates the joint definitions of the preferred embodiment of the MBS: the slider joint 100, the pin joint 102, and the ball joint 104. Each joint allows translational or rotational displacement of the hinge point Qₖ 106 relative to the inboard hinge point Pₖ 108. These displacements are parameterized by q(k) 110, the generalized coordinates for body k. In passing, it should be noted that generalized coordinates are examples of generalized quantities, which refer to quantities that have both rotational character and translational character. For instance, a generalized force acting at a point consists of both a force vector and a torque vector. The generalized coordinate q(k) for the slider joint 100 is the sliding displacement x 112. The generalized coordinate q(k) for the pin joint 102 is the angular displacement θ 114. The generalized coordinate q(k) for the ball joint 104 is the Euler parameters (≮₁,≮₂,≮₃,≮₄) 116.

Each joint may be a pin, slider, or ball joint; or a combination of these joints. Many other joint types are possible, including, but not limited to, free joints, U-joints, cylindrical joints, and bearing joints. For instance, q(k)=(x,y,z), the inertial measure numbers of the vector from the base body inboard hinge point to the base body hinge point express the base body displacement in ground as three orthogonal slider joints. A free joint consists of three orthogonal slider joints combined with a ball joint, and has the full 6 degrees of freedom.

The collection of generalized coordinates for all the bodies comprises the vector q, the generalized coordinates for the system.

Given the generalized coordinates for a particular joint, two quantities: r^{P}^{_{λ}}^{Q}^{ₖ}(k), the joint translation vector and ⁱC^{k}(k), the direction cosine matrix for body k in its parent are formed. The translation vector r^{P}^{ₖ}^{Q}^{ₖ}(k) expresses the vector from the inboard hinge point P of body k to the hinge point Q of body k, in the coordinate frame of the parent body. Details of these computations depend on the joint type and can be easily derived. For purposes of this description, access to a function that can generate r^{P}^{ₖ}^{Q}^{ₖ}(k) and ⁱC^{k}(k) given the system generalized coordinates is assumed.

As introduced, the choice of hinge point for each body is arbitrary. However, judicious choice greatly simplifies matters. For instance, for pin joints the hinge point should be chosen as a point on the axis of the joint. For this choice points P and Q remain coincident for all values of the joint angle, so the joint translation is zero. If the point Q is chosen at a distance from the axis, points P and Q move relative to each other:

r^{P}^{ₖ}^{Q}^{_{λ}}(k)=λ×r^{OQ}^{ₖ}sinθ−(1−cosθ) (E₃−λλ^{*})r^{OQ}^{ₖ}

where λ is the joint axis unit vector, θ is the joint angle, and r^{OQ}^{ₖ} is the vector from any point on the axis to point Q.

For pin joints and ball joints, a point on the axis is always chosen as the hinge point. For these joints the translation vector r^{P}^{ₖ}^{Q}^{ₖ}(k) is zero.

For a slider joint, the translation vector r^{P}^{ₖ}^{Q}^{ₖ}(k) is q(k)λ.

The direction cosine matrix for a pin is

ⁱC^{k}(k)=E₃cos θ+\tilde{λ}sin θ+λλ^{*}(1−cos θ)

The direction cosine matrix for a slider is E₃.

Generalized Speeds of the Model

Let ⁱV^{k}(k), the generalized velocity of the hinge point of body k measured in its parent i, be parameterized by u(k), a set of generalized speeds. Then:

$${}^{i} {V}^{k} ( k ) = ( \begin{matrix}{}^{i} {ω}^{k} ( k ) \\ {}^{i} {v}^{{Q}_{k}} ( k )\end{matrix} ) = {H}^{*} ( k ) u ( k )$$

Here, the matrix H(k) is called the joint map for this joint. It is a nᵤ(k) by 6 matrix, where nᵤ(k) is the number of degrees of freedom for the joint (1 for a pin or slider, 3 for a ball, 6 for a free joint). H(k) can, in general have dependence on coordinates q. Given the generalized speeds for the joint, the joint map generates the joint linear and angular velocity, expressed in the child body frame. The following are used for the joints:

$$H ( k ) = [ \begin{matrix}\underline{λ} & 0 & 0 & 0 ]\end{matrix} , pin \\ H ( k ) = [ \begin{matrix}0 & 0 & 0 & \underline{λ} ]\end{matrix} , slider \\ H ( k ) = [ \begin{matrix}{\underline{\underline{E}}}_{3} & {\underline{\underline{0}}}_{3} ]\end{matrix} , ball \\ H ( k ) = [ \begin{matrix}{\underline{\underline{E}}}_{3} & {\underline{\underline{0}}}_{3} \\ {\underline{\underline{0}}}_{3} & {}^{i} {C}^{k} ( k )\end{matrix} ] , free$$

The collection of generalized speeds for all the bodies comprises the vector u, the generalized coordinates for the system. As before, access to a function that can generate the vector ⁱV^{k}(k) given (q,u) and a specific joint type, is assumed. Access to a function that can compute the derivatives \dot{q}(k)=\dot{q}(q(k),u(k)) is also assumed. This routine generates the time derivative of the generalized position coordinates:

\dot{q}=W(q)u

where W(q) is a block diagonal matrix that relates \dot{q} and u, with each block depending upon the joint type:

$$\dot{q} = u for pin joint , slider joint \\ [ \begin{matrix}{\dot{ϵ}}_{1} \\ {\dot{ϵ}}_{2} \\ {\dot{ϵ}}_{3} \\ {\dot{ϵ}}_{4}\end{matrix} ] = \frac{1}{2} [ \begin{matrix}{ϵ}_{4} & - {ϵ}_{3} & {ϵ}_{2} \\ {ϵ}_{3} & {ϵ}_{4} & - {ϵ}_{1} \\ - {ϵ}_{2} & {ϵ}_{1} & {ϵ}_{4} \\ - {ϵ}_{1} & - {ϵ}_{2} & {ϵ}_{4}\end{matrix} ] [ \begin{matrix}{ω}_{1} \\ {ω}_{2} \\ {ω}_{3}\end{matrix} ] for ball joint$$

$$where q = {[ \begin{matrix}{ϵ}_{1} & {ϵ}_{2} & {ϵ}_{3} & {ϵ}_{4}\end{matrix} ]}^{*} and u = {[ \begin{matrix}{ω}_{1} & {ω}_{2} & {ω}_{3}\end{matrix} ]}^{*}$$

and a free joint is a combination of 3 slider joints and one ball joint. Note that there are 4 \dot{q}'s (derivatives of the Euler parameters) associated with 3 u 's for ball joints.

Similarly, ¹A^{k}(k), the generalized acceleration of the hinge point of body k in its parent, is given by:

$${}^{i} {A}^{k} ( k ) = ( \begin{matrix}{}^{i} {α}^{k} ( k ) \\ {}^{i} {α}^{{Q}_{k}} ( k )\end{matrix} ) = {H}^{*} ( k ) \dot{u} ( k )$$

It is these generalized coordinates q, and generalized speeds u, the internal coordinates for purposes of this description, of the molecular system which are calculated. Rather than working with the typical inertial coordinates (x,y,z) and speeds in these inertial coordinate systems, calculations for the subject molecular system are reduced.

CALCULATIONS OF THE EQUATIONS OF MOTION

With the exemplary rigid multibody, torsion angle model described, the equations of motion can now be calculated. In accordance with the present invention, the motion of the MBS molecular model is determined by the Residual Form. The Residual Form method requires calculations termed the “first” kinematic calculations to distinguish them from the “second” kinematic calculations, which are further required by the Direct Form (which is included in this description for purposes of comparison).

First Kinematic Calculations for the Molecular Model

In the first kinematic calculations, given the internal coordinates of the molecular system, (q,u,\dot{u}) and the system parameters, the following position, velocity and acceleration kinematics are computed for each rigid body k of the molecular model. (In passing, it should be noted that when the First Kinematic calculations are done for the Residual Form method, the \dot{u} is passed in as a guess of the solution which the integration method then refines to the correct solution. In contrast, \dot{u} is set to zero when used for the Direct Form method. This is shown clearly in the later descriptions of the two methods.)

For each body k compute:

^{N}C^{k}(k), r^{Q}^{ᵢ}^{Q}^{ₖ}(k), r^{OQ}^{ₖ}(k),ⁱφ^{k}(k),

^{N}ω^{k}(k), ^{N}v^{Q}^{ₖ}(k), V(k),

^{N}α^{k}(k), ^{N}α^{Q}^{ₖ}(k), A(k),

These computations are done recursively, starting from each base body and progressing to the leaves.

^{N}C^{k}(k), the direction cosine matrix for body k in ground is defined as:

^{N}C^{k}(l)=ⁱC^{k}(l)

^{N}C^{k}(k)=^{N}C^{k}(i)ⁱC^{k}(k), k=2, . . .n, i=inb(k)

ⁱC^{k}(k) comes from the joint routine described above.

r^{Q}^{ᵢ}^{Q}^{ₖ}(k), the position vector from Qᵢ, the hinge point of the parent of body k to Qₖ, the hinge point of body k, expressed in the parent frame, is defined as:

r^{Q}^{ᵢ}^{Q}^{ₖ}(k)=d(k)+r^{P}^{ₖ}^{Q}^{ₖ}(k), k=1, . . . n

r^{P}^{ₖ}^{Q}^{ₖ}(k) comes from the joint routine.

r^{OQ}^{ₖ}(k), the position vector from the inertial origin O to Qₖ, the hinge point of body k, expressed in the global frame, is defined

r^{OQ}^{ₖ}(l)=r^{Q}^{ᵢ} ^{Q}^{ₖ}(l)

r^{OQ}^{ₖ}(k)=r^{OQ}^{ₖ}(i)+^{N}C^{k}(i)rQ^{ᵢ}^{Q}^{ₖ}(k), k=2, . . .n, i=inb(k)

ⁱφ^{k}(k), the rigid body transformation operator for body k is defined

$${}^{i} {φ}^{k} ( k ) = ( \begin{matrix}{}^{i} {C}^{k} ( k ) & {{\tilde{r}}^{{Q}_{i} {Q}_{k}} ( k )}^{i} {C}^{k} ( k ) \\ {\underline{\underline{0}}}_{3} & {}^{i} {C}^{k} ( k )\end{matrix} ) , k = 1 , … n$$

V(k), the spatial velocity for body k at its hinge point, expressed in the frame of body k, is defined

$$V ( 1 ) {=}^{△} ( \begin{matrix}{}_{}^{N}{ω}{}_{}^{k} ( 1 ) \\ {}_{}^{N}{v}{}_{}^{{Q}_{k}} ( 1 )\end{matrix} ) = {}_{}^{i}{V}{}_{}^{k} ( 1 )$$

$$V ( k ) {=}^{△} ( \begin{matrix}{}_{}^{N}{ω}{}_{}^{k} ( k ) \\ {}_{}^{N}{v}{}_{}^{{Q}_{k}} ( k )\end{matrix} ) = {}_{}^{i}{φ}{}_{}^{k *} ( k ) V ( i ) + {}_{}^{i}{V}{}_{}^{k} ( k ) , k = 2 , … n , i = inb ( k )$$

A(k), the spatial acceleration for body k at its hinge point, expressed in the frame of body k, is defined

$$A ( 1 ) {=}^{△} ( \begin{matrix}{}_{}^{N}{α}{}_{}^{k} ( 1 ) \\ {}_{}^{N}{a}{}_{}^{{Q}_{k}} ( 1 )\end{matrix} ) = {}_{}^{i}{A}{}_{}^{k} ( 1 )$$

$$A ( k ) {=}^{△} ( \begin{matrix}{}_{}^{N}{α}{}_{}^{k} ( k ) \\ {}_{}^{N}{a}{}_{}^{{Q}_{k}} ( k )\end{matrix} ) = \overline{A} + ( \begin{matrix}\tilde{ω} & {\underline{\underline{0}}}_{3} \\ {\underline{\underline{0}}}_{3} & 2 \tilde{ω}\end{matrix} ) {}_{}^{i}{V}{}_{}^{k} ( k ) + {}_{}^{i}{A}{}_{}^{k} ( k ) , k = 2 , … n , i = inb ( k )$$

where

$$\overline{A} = {}_{}^{i}{φ}{}_{}^{k *} ( k ) A ( i ) + ( \begin{matrix}{\underline{0}}_{3} \\ {}_{}^{i}{C}{}_{}^{k *} ( k ) ( {}_{}^{N}{ω}{}_{}^{k} ( i ) \times {}_{}^{N}{ω}{}_{}^{k} ( i ) \times {r}^{{Q}_{i} {Q}_{k}} ( k ) )\end{matrix} )$$

$$ω = {{}_{}^{i}{C}{}_{}^{k *} ( k )}^{N} {ω}^{k} ( i )$$

Of course, the computations can all be computed in a single pass if desired.

After completing these steps for one incremental time step, the MBS can service kinematics requests to compute the (generalized) position, velocity, or acceleration information for any point of any body. This is done by computing the required information for any point in terms of the hinge quantities for its body, using standard rigid body formulas.

Residual Computation

With the first kinematic calculations described above, the residual computation for the Residual Form method can be determined. This computation fills in two partitions of the vector

$$( \begin{matrix}{ρ}_{q} \\ {ρ}_{u}\end{matrix} )$$

given previously. The first partition is called ρq, the kinematic residual, and the second partition is called ρu, the dynamic residual. The kinematic residual is computed from the difference between a \dot{q}, which is passed-in from the (implicit) integration submodules 66, and the derivative computed by each joint:

\dot{q}−W(q)u=ρq

The dynamics residual is also computed. Starting with a given state of the molecular model, i.e., given (q,u,\dot{u}) and the system parameters, a program routine models the ‘environment’ of the MBS. Such routines are readily available to, or can be created by, practitioners in the computer modeling field. The routine takes the values (q,u) determined by and passed in from the integration submodules 66 and returns (the state-dependent)

$$T ( k ) = ( \begin{matrix}{T}_{{Q}_{k}} ( k ) \\ F ( k )\end{matrix} ) ,$$

the applied spatial force for a body k at its hinge point Qₖ, and σ(k), the hinge torque for the body k. The dynamics residual, ρᵤ(k), associated with generalized speeds u(k) for the body k is then computed by the following steps:

1. Perform the calculations for the molecular model by the Residual Form as described above with the passed-in state values (q,u,\dot{u});

2. Generate \hat{T}(k), the spatial load balance for each body k in the model having n bodies:

$$\hat{T} ( k ) = M ( k ) A ( k ) + ( \begin{matrix}{}_{}^{N}{\tilde{ω}}{}_{}^{k} ( k ) ( {\underline{\underline{I}}}_{{Q}_{k}} ( k ) {}_{}^{N}{ω}{}_{}^{k} ( k ) ) \\ {}_{}^{N}{\tilde{ω}}{}_{}^{k} ( k ) ( {}_{}^{N}{ω}{}_{}^{k} ( k ) \times p ( k ) )\end{matrix} ) - T ( k )$$

$$k = 1 , … n$$

3. Compute ρu(k)

for k=n to 2 by −1

ρᵤ(k)=H(k)\hat{T}(k)−σ(k)

i=inb(k)

\hat{T}(i)+=ⁱ100 ^{k}(k)\hat{T}(k)

end

ρᵤ(l)=H(l)\hat{T}(l)

The Residual Form method evaluates the extent to which the system differential equations are satisfied. Zero residual indicates that the applied forces are in balance with the inertia forces. However, this does not mean the system is in static equilibrium, but rather that the applied forces would reproduce the given it when applied to the system in the state (q,u). The residuals can be interpreted as that additional hinge torque needed to balance the applied and inertia forces. In the literature this method is known as either inverse dynamics, or the method of computed torques. It governs the case where the \dot{u} are all prescribed. At this point all the computations required for the Residual Form are complete. The residuals ρq and ρu are used directly by the implicit integrator in the integrator submodule 68.

To demonstrate the computational advantage of the Residual Form method, the Direct Form method for the equations of motion is also described with the same molecular model described above. The computational advantage is clearly shown by comparing operation counts of the Residual Form method and the Direct Form method for molecular models for molecules of different sizes.

Second Kinematics Calculations for the Molecular Model

To carry out the Direct Form method, calculations in addition to the first kinematics calculations are required. These additional calculations are termed the second kinematics calculations. The values P(k), D(k), ⁱψ^{k}(k), ⁱK^{k}(k) are computed as follows:

1. Perform the calculations for the Molecular Model by the Residual Form as described above, i.e., the first kinematics calculations.

2. P(k), the articulated body inertia of each body k, is initialized.

P(k)=M(k), k=1, . . . ,n

3. The objects below are then generated:

$$Sent back to annotation$$

The functional dependence of these quantities is only upon the generalized coordinate q. Therefore, the first kinematics calculations are programmed in anticipation of performing the second kinematics calculations.

Forward Dynamics Calculations

Finally, we can compute \dot{u} by sweeping inboard, then outboard:

$$Sent back to annotation$$

end

With the First and Second Kinematics Calculations, and the Forward Dynamics Calculations, the Direct Form method is available.

Direct Form Method for the Equations of Motions

The Direct Form method takes the current state (q,u) and computes the derivatives (\dot{q}, \dot{u}) using the above algorithms, which are then used by the integration method to advance time.

Given: (q,u)

Compute: (\dot{q},\dot{u})

1. Compute \dot{q} using joint specific routine as above

2. Perform above first kinematics calculations with \dot{u}=0

3. Generate residuals ρu as above

4. Negate the residuals ρu=−ρu

5. Perform second kinematics calculations

6. Compute \dot{u} using forward dynamics step above

The Direct Form method produces the hinge accelerations \dot{u} in response to the applied forces acting on the system.

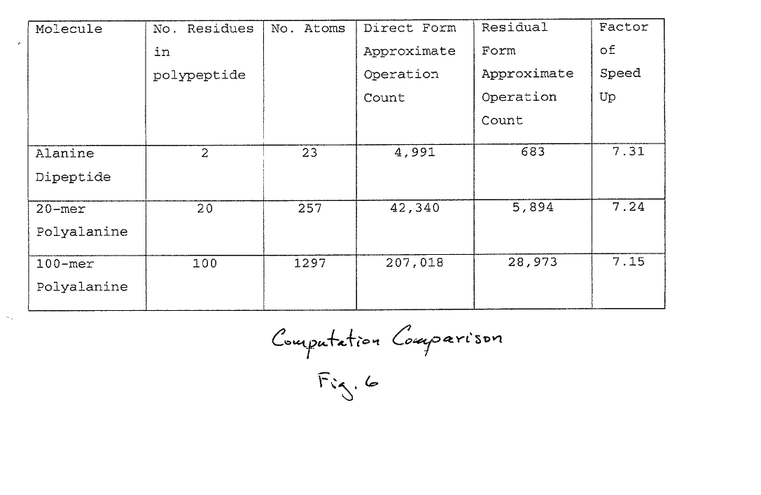

FIG. 5 summarizes the computation steps of the Residual Form method and the Direct Form method. It should be evident that since the Direct Form method includes the calculations of the Residual Form method, the Direct Form method is more computationally intensive that the Residual Form method. Stated differently, the Residual Form method requires less computer time to advance the molecular model in time.

FIG. 6 illustrates the computations required for the standard Direct Form method of the MD equations versus the Residual Form method. The operation count is for the preferred embodiment of using Order(N) torsion angle formulation. Several size polypeptide molecules from 2 to 100 amino acid residues are shown. The operation count is reduced approximately by a factor of 7 for the Residual Form method.

Hence the present invention improves the speed with which accurate molecular dynamics simulations can be performed. The method allows a numerical integration algorithm to utilize a representation of the differential equations that requires fewer arithmetic operations to evaluate than previous methods. The Residual Form method of the equations includes 0=M\dot{u}−f whereas the Direct Form method includes \dot{u}=M⁻¹f . The Direct Form method requires evaluation of the state derivatives, and while this can be done efficiently using Order(N) methods, the Residual Form can be computed with less cost. In addition, an analytical Jacobian of the residual equations can be formed at less cost than the analytical Jacobian of the direct equations (see previously referenced co-pending application, U.S. patent application. Ser. No. ______, entitled, “METHOD FOR ANALYTICAL JACOBIAN COMPUTATION IN MOLECULAR MODELING,” and filed on even date. A Jacobian is required by stable implicit integration methods and its formation is often the most time-consuming step in such methods.

The use of the Residual Form method can be applied to many forms of molecular modeling including, but not limited to:

Constrained models of molecules with closed loops, as well as open tree structures. The constraint equations are typically adjoined to the equations of motion, such as, but not limited to: M\dot{u}=f−A^{T}λ, where A is the constraint matrix and λ are the Lagrange multipliers (note that A is not the same as the generalized acceleration ⁱA^{k}(k), and λ is not the same as the vector k which defines an MBS joint axis);

Cartesian, or other formulations of the molecular models;

Any order of the equations to be solved, including, but not limited to Order(N), Order(N²), Order(N³), and Order(N⁴);

All-atom models, rigid-body models, flexible-body models or combinations these models.

Additionally, the Residual Form method can work with many implicit integration methods, including, implicit Euler, Radau5, SDIRK3, SDIRK4, and other implicit Runge-Kutta methods, as well as DASSL and other implicit multistep methods.

With the Residual Form method according to the present invention, biomolecular systems, especially for protein and RNA including, but not necessarily limited to, folding, interactions with small drug-like molecules, and functions, such as conformational changes and binding, are effectively simulated.

Therefore, while the foregoing is a complete description of the embodiments of the invention, it should be evident that various modifications, alternatives and equivalents may be made and used. Accordingly, the above description should not be taken as limiting the scope of the invention which is defined by the metes and bounds of the appended claims.

What is claimed is:

1. A method of computer modeling the behavior of a molecule or set of molecules, comprising
selecting a model for said molecules, said model having equations of motion for said molecule;
formulating said equations of motion in Residual Form; and
integrating said model equations with an implicit integrator;
whereby computer calculations for said molecular behavior are reduced.

2. The method of claim 1 wherein said equations of motion in Residual Form comprise
$$( \begin{matrix}{ρ}_{q} \\ {ρ}_{u}\end{matrix} ) = ( \begin{matrix}\dot{q} - W ( q ) u \\ M ( q ) \dot{u} - f ( t , q , u )\end{matrix} )$$
where q represents generalized system coordinates, u represents generalized velocities, W represents a generalized joint map matrix, M represents generalized system mass, f represents generalized system forces, and t represents time.

3. The method of claim 2 wherein said integrating step is performed iteratively and residuals
$$( \begin{matrix}{ρ}_{q} \\ {ρ}_{u}\end{matrix} )$$
are reduced below predetermined amounts before a next iterative integration step is performed.

4. The method of claim 1 wherein said model comprises
a plurality of rigid bodies, each rigid body representing a portion of said molecule; and
a plurality of hinge connections, each hinge connection defining allowable relative motion between two of said rigid bodies.

5. The method of claim 4 wherein each hinge connection comprise a connection selected from the group comprises a sliderjoint, a pin joint, a ball joint, a free connection, and combinations thereof.

6. The method of claim 5 wherein q correspond to internal coordinates of one of said rigid bodies with respect to another of said rigid bodies.

7. The method of claim 6 wherein said internal coordinates comprise a linear displacement of said one rigid body with respect to said another rigid body.

8. The method of claim 6 wherein said internal coordinates comprise an angular displacement of said one rigid body with respect to said another rigid body.

9. The method of claim 6 wherein said internal coordinates comprise Euler parameters of said one rigid body with respect to said another rigid body.

10. The method of claim 6 wherein M comprises a system mass matrix.

11. The method of claim 6 wherein f comprises a bias-free hinge torque.

12. The method of claim 1 wherein said implicit integrator comprises an L-stable integrator.

13. The method of claim 12 wherein said L-stable integrator comprises an integrator from the group comprising implicit Euler, Radau5, SDIRK3, SDIRK4 and other implicit Runge-Kutta methods.

14. A method of claim 1 wherein said implicit integrator comprises an integrator from the group comprising DASSL and other implicit multistep methods for ODE or DAE systems.

15. A method of computer modeling the behavior of a molecule, said molecule having a plurality of bodies having masses, said method comprising
selecting a model for said molecule, said model having equations of motion for said molecule;
formulating said equations of motion such that mass matrices corresponding to said masses for said plurality of bodies are not inverted; and
integrating said model equations with an implicit integrator; whereby computer calculations for said molecular behavior are reduced.

16. The method of claim 15 wherein said equations of motion are in Residual Form.

17. The method of claim 15 wherein said implicit integrator comprises an L-stable integrator.

18. The method of claim 17 wherein said L-stable integrator comprises an integrator from the group comprising implicit Euler, Radau5, SDIRK3, SDIRK4 and other implicit Runge-Kutta methods.

19. A method of claim 15 wherein said implicit integrator comprises an integrator from the group comprising DASSL and other implicit multistep methods for ODE or DAE systems.

20. Computer code for modeling the behavior of a molecule, said code comprising
a model for said molecule, said model having equations of motion for said molecule, said equations of motion formulated in Residual Form; and
an implicit integrator for integrating said model equations over time;
whereby computer calculations from said code to model said molecular behavior are reduced.

21. The computer code of claim 20 wherein said equations of motion in Residual Form comprise
$$( \begin{matrix}{ρ}_{q} \\ {ρ}_{u}\end{matrix} ) = ( \begin{matrix}\dot{q} - W ( q ) u \\ M ( q ) \dot{u} - f ( t , q , u )\end{matrix} )$$
where q represents generalized system coordinates, u represents generalized velocities, W represents a generalized joint map matrix, M represents generalized system mass, f represents generalized system forces.

22. The computer code of claim 21 wherein said implicit integrator integrates said model equations iteratively, and after residuals
$$( \begin{matrix}{ρ}_{q} \\ {ρ}_{u}\end{matrix} )$$
are reduced below predetermined amounts before a next iterative integration is performed.

23. The computer code of claim 21 wherein said model comprise
a plurality of rigid bodies, each rigid body representing a portion of said molecule;
and a plurality of hinge connections, each hinge connection defining allowable relative motion between two of said rigid bodies.

24. The computer code of claim 23 wherein each hinge connection comprise a connection selected from the group comprises a slide joint, a pin joint, a ball joint, and combinations thereof.

25. The computer code of claim 24 wherein q correspond to internal coordinates of one of said rigid bodies with respect to another of said rigid bodies.

26. The computer code of claim 24 wherein said internal coordinates comprise a linear displacement of said one rigid body with respect to said another rigid body.

27. The computer code of claim 24 wherein said internal coordinates comprise an angular displacement of said one rigid body with respect to said another rigid body.

28. The computer code of claim 24 wherein said internal coordinates comprise Euler parameters of said one rigid body with respect to said another rigid body.

29. The computer code of claim 24 wherein M comprises a system mass matrix.

30. The computer code of claim 24 wherein f comprises a bias-free hinge torque.

31. The computer code of claim 20 wherein said implicit integrator comprises an L-stable integrator.

32. The computer code of claim 31 wherein said L-stable integrator comprises an integrator from the group comprising implicit Euler, Radau5, SDIRK3, SDIRK4 and other implicit Runge-Kutta methods.

33. A method of claim 20 wherein said implicit integrator comprises an integrator from the group comprising DASSL and other implicit multistep methods for ODE or DAE systems.
